(19) United States
(12) Patent Application Publication
(10) Pub. No.: US 2004/0012551 A1
(43) Pub. Date: Jan. 22, 2004

(54) Adaptive overdrive and backlight control for TFT LCD pixel accelerator

(76) Inventor: Takatoshi Ishii, Sunnyvale, CA (US)

Correspondence Address: PILLSBURY WINTHROP LLP, 1600 Tysons Boulevard, McLean, VA, 22102, US

(21) Appl. No.: 10/262,618

(22) Filed: Sep. 30, 2002

Related U.S. Application Data
(60) Provisional application No. 60/396,456, filed on Jul. 16, 2002.

(51) Int. Cl. G09G 3/36

(52) U.S. Cl. 345/87; 345/102

(57) ABSTRACT

A configuration/apparatus to drive emphasized data to an LCD screen, including enhancing frame difference data with compensation and enhancement factors. These factors can consider a backlight phase input from a variable backlight control system.

### RELATED APPLICATIONS

This application claims priority from a provisional patent application entitled “Adaptive Overdrive And Backlight Control For TFT LCD Pixel Accelerator” filed on Jul. 16, 2002 and bearing Ser. No. 60/396,456.

### BACKGROUND

1. Field of the Invention

The invention is related to improvement of a liquid-crystal display (LCD) control and driving scheme. Particularly, it relates to acceleration of the pixel response and the speed of an active matrix liquid crystal display panel. It relates to improvement the performance of motion picture presentation of active matrix liquid crystal display panel.

2. Related Art

Active matrix liquid crystal (also called “TFT LCD” (Thin Film Transistor Liquid Crystal Display)) display panels are widely in use in PC (Personal Computer) based display applications, such as notebook PCs and PC monitors, because they provide light weight, thin thickness, and low power consumption features. Moreover, recent efforts to develop high performance TFT LCD panels are resolving limitations of conventional panel performance, such as resolution, contrast, brightness, and viewing angle. It is expected that LCD monitor unit shipping number will become larger than CRT (Cathode Ray Tube) monitor shipping in the PC monitor market in near future. Further, the demand for multimedia and thus, LCD, is expected to become stronger, since the types of image sources are expanded from only PC-based still information to motion pictures from DVD (Digital Video Disc) players, video games, digital TVs and so on.

However, one drawback of LCD performance for motion video is slow response time. The response time in LCD tends to be slower in grayscale, and the worst values in TN LC (twisted nematic liquid crystal) material reaches 4 to 5 frame periods. This deteriorates display quality in moving images greatly, and results in ghosting and reduced resolution in the moving image. In order to resolve this issue, fast response LC materials have been developed. However, unfortunately these have not been sufficient in improving the slow response time in grayscale, since the origin of slow response is related to LC operation dynamics.

As mentioned above, conventional active matrix liquid crystal display (TFT LCD) uses TN LC (twisted nematic liquid crystal) material. The response time of a liquid crystal display is directly related to the driving voltage changes, changes that depend on the starting tone and the targeting tone. The response time of black to white or white to black is comparatively as late as 30-50 milliseconds. Moreover, the response times to the middle tone from other tones, like the middle tone from white, the middle tone from black, and a certain middle tone from other middle tones, are very slow and as late as 50-100 milliseconds. When the screen has so many middle tone images, such as TV images, and when the display shows moving image, a residual image phenomenon where the image still lingers in the wrong position is generated.

Moreover, all of the existing and conventional liquid-crystal display panel schemes use a display system of a so called “hold type,” which continues to display a picture of one frame interval during the period which is in the same one cycle of a picture signal. If moving images, such as TV images, are displayed on this hold-type liquid-crystal display, the picture, which is moving frame by frame, is displayed for one frame in the same position. In order to pursue the tracing edges viewed by the human eye, averaging happens to those moving edges of the pictures on the eye retina and hence the human eye will recognize these images as the blurring outline in a picture.

As mentioned above, in displaying a moving image on a liquid-crystal display, two problems exist. To solve the first problem, when display data has changed, detected with the display data of the previous frame, the display data is then emphasized and written into the driver more than the amount of the change to the pixel data. Several emphasizing schemes (commonly called over-driving) of changing display data currently exist and are named based on different theoretical concepts, for example: LAO (level adaptive over-drive), FFD (feed-forwarding drive), and DCC (dynamic contrast compensation or dynamic charge compensation). All of these schemes use a simple algorithm with a full frame buffer. The response speed of a middle tone response becomes almost equivalent to the response speed of a white display or a black display and the residual images at the time of moving display are improved to some extent by these schemes. But, all of these schemes fall short and are not applicable in mass-production with reasonable low cost and price.

Regarding the second problem, within one frame interval, there is an experimental scheme to eliminate edge blurring by driving the liquid-crystal panel by more than 2 times faster than the frame speed, turning on back-light only the second half of frame interval, and it must use the double speed response liquid crystal material. Another scheme uses the insertion of a black-screen data in the first half and similarly by driving the display data in the second half of the frame interval. This can eliminate human visual feeling of blurring edges. However, these schemes can be utilized only under some special limitations and only at the laboratory level. Further there is an existing problem of how to apply these schemes in low cost mass-production products.

FIG. 1 is a block diagram of a computer system to explain the background of display sub-systems as they relate to computer systems. System 100 includes a CPU (Central Processor Unit) 105, coupled to a System/Host Bus 140, for accessing all system resources, to execute parameter setting for all system configuration, to perform I/O operation, to execute software program, and to update display information, and so on.

System 100 also includes Memory Sub-System 110, Peripheral Sub-System 120, and Display Sub-System 130, coupled to System/Host Bus 140. Memory Sub-System 110 comprises Random Access Memory (RAM) 112 and Read Only Memory (ROM) 114. Memory subsystem 110 typically stores miscellaneous data, some programs for execution by CPU, and intermediate results of executing programs. Peripheral Sub-System 120 includes a keyboard 128, a printer 126, a disk 124, and other peripheral interfaces. The disk 124 can be used as a secondary external memory for CPU data and programs.

Display Sub-System 130 includes a display controller 132, a display memory 134, and a display device 136. Display device 136 is a CRT or an LCD. In some cases both devices can be included in the system as operating simultaneously. The Display Sub-System 130 performs screen refreshing for such display devices as monitors or LCD screens.

FIG. 2(a) is a detailed view of a conventional display sub-system. The CPU 105 executes parameter setting for all registers in this Display Sub-System when initializing after system power up. The Display Sub-System has several registers in it and CPU writes all initializing values to the registers that are needed to initialize. In some cases, such as when operation mode changing happens, the CPU 105 re-writes those registers that are needed to meet the new operation mode. The CPU 105 sends the update values to Parameter Registers 233 through System/Host Bus 140 in the case. Parameter Registers 233 receive all necessary parameters to specify all values for registers in each module of the Display Sub-System.

Sync/Timing Generator 235 generates synchronous signals and timing signals based on those parameter values. The synchronous signals and timing signals are distributed and used to control operation inside the Display Sub-System.

CPU 105 updates information to be displayed on the display device through System/Host Bus 140 (such as ISA or PCI bus) when display data are changed. The update information are transferred to and from FIFO Buffer 236 with the aid of Host/CPU Interface 234 (ISA or PCI bus interface controller). These are industry-standard interface buses that include address decoder logics.

Memory Controller 238 transfers host data between FIFO Buffer 236 to and from Display Memory 134 based on a reading or writing request from System/Host Bus 140. When CPU 105 requests reading data, Memory Controller 238 receives read address from FIFO Buffer 236. Memory Controller 238 issues read command to Display Memory 134 specifying received read address and executes reading. Memory Controller 238 returns the read data to FIFO Buffer 236.

When CPU 105 requests writing data, Memory Controller 238 receives write data and its address to store from FIFO Buffer 236 and issues write command to Display Memory using received write data and address. After finishing write operation, Memory Controller 238 checks next request from System/Host Bus 140 and enters next operation.

Display/Scan Address Generator 237 generates the memory address for the display scan in order to read screen refresh data as display data to the display device. Memory Controller 238 reads the display data and transfers it to Attribute Controller 239. These data transfers occur concurrently between Display Memory 134 to and from FIFO Buffer 236, and Display Memory 134 to Attribute Controller 239.

Attribute Controller 239 may re-map or alter the color represented by the display data using a Register Color Look-Up Table and by outputting Pixel Data. Attribute Controller 239 may apply other attribute functions, such as blinking or reverse-video characters.

RAM DAC 240 receives the Pixel Data. It is modified by Attribute Controller 239. RAM DAC 240 contains RAM Color Look-Up Tables which are indexed by Pixel Data, and output digital values for red, green, and blue sub-pixels that comprise a color pixel. RAM DAC 240 also contains three digital-to-analog converters (DAC) that convert the digital color sub-pixel data to analog intensity values (analog RGB signals) that are transmitted to the CRT Display 210. It also outputs CRT vertical and horizontal synchronous signals to CRT Display 210.

RAM DAC 240 output Digital Pixel Data to LCD Interface 241. The Digital Pixel Data are taken from the output of RAM Color Look-Up Tables, after the RAM has been accessed and has output the digital sub-pixels, but before conversion to analog values. LCD Interface 241 may perform a gray-scale conversion of the color sub-pixels if the display device is STN LCD (Super Twisted Nematic Liquid Crystal Display). Or it may perform some other conversion of the Pixel Data to a format that is acceptable to LCD Display 220. The converted pixel data is output from LCD Interface to the LCD Display 220. LCD Interface 241 has LCD panel timing control signals and clock signals with the converted (digital) pixel data to the LCD Display 220. LCD Display 220 may itself includes some additional control or conversion logic to manipulate the pixel data before it is displayed on a screen visually, and it may be implemented on many different types and in many different technologies.

FIG. 2(b) is an example of a frame buffer with a data compression scheme. This example frame buffer 280 uses publicly well-known CSC (color space conversion) scheme. The CSC compression scheme and motion picture frame buffer application are compatible, because original data format of motion picture images are usually video color space data format.

Input data to the scheme are 18-bit RGB data and are converted to 6-bit YCrCb format (block 288) and written into memory block 281. These data read out and recovered to 18-bit RGB data format (block 282) and output as FBDT after just one frame interval.

The memory timing controller 286 and memory read/write control 284 blocks generate necessary memory control timing and address signals to execute just one frame time delay line between input to output data. The targeted compressed Frame Buffer size is 160 KB SRAM.

### SUMMARY

The invention in various embodiments discloses a composition/configuration in which blurring edges and residual images can be eliminated when displaying moving video images. The invention can provide, by using usual LCD back-light, without using special high speed and fast response liquid crystal material for the active matrix liquid crystal display, good quality moving display images without blurring edges and no residual image anomalies. The invention includes the use of a data emphasizer for outputting drive data to a LCD display and utilizes a back light control system in generating this drive data.

### BRIEF DESCRIPTION OF DRAWINGS

FIG. 1 is a block diagram of a computer system to explain the background of display sub-systems as they relate to computer systems.

FIG. 2(a) is a detailed view of a conventional display sub-system.

FIG. 2(b) is an example of a frame buffer with a data compression scheme.

FIG. 3 illustrates a TFT LCD panel system block diagram according to at least one embodiment of the invention.

FIG. 4 is an example of a DATA Emphasizer for an over-drive algorithm according to the invention.

FIG. 5 illustrates an example of a DATA Emphasizer block detail for an adaptive over-drive algorithm.

FIG. 6 illustrates an example of a DATA Emphasizer block for an adaptive over-drive algorithm with a BLPH signal input.

FIG. 7 illustrates an example of a Conversion Table block for an adaptive over-drive algorithm with a BLPH signal input.

FIG. 8 illustrates an example of a backlight timing generator.

FIG. 9 illustrates a timing chart 900 of backlight related signals.

FIG. 10 is an example of a Xenon tube backlight high voltage generator and trigger circuit 1000.

FIG. 11 is an exemplary embodiment of a DATA emphasizer for adaptive over-drive output with a BLPH input.

FIG. 12 is an exemplary adaptive over-drive data and intensity timing chart.

FIG. 13 exemplifies adaptive over-drive data and timing chart 1300 with BLPH control.

FIG. 15 is another example of adaptive over-drive intensity timing chart 1500 with BLPH compensation control.

FIG. 16 is an example of adaptive over-drive intensity timing chart 1600 with two lightings.

FIG. 17 is an example of a video window detecting timing generator.

FIG. 18 is a diagram of video window and display timing.

### DETAILED DESCRIPTION

The invention provides a means to drive the data for the value corresponding to the present frame display data and by comparing with the previous frame of display data, the display data in the present frame that has the changes, the display data are then over emphasized and written into the LCD driver with more than the amount of change to the pixel data. Furthermore, in connection with the display data that is emphasized previously, a means to apply emphasizing one after another frames and a means to change enhancement and compensation factor with two or more frames is provided. Furthermore, a backlight control means to control the lighting delay time, the lighting time width, the lighting interval, and the number of times of lighting within one frame of a liquid-crystal back lighting is provided. Furthermore, a means to change the above enhancement and compensation factors related between the liquid-crystal back lighting control of delay time, time width, interval, number of times and with the position on the screen of display data relative to backlight lighting control timing is provided. Without using extremely high-speed and fast response liquid crystal material, the residual image and blurring anomalies are eliminated, when moving video pictures or images are displayed. The invention provides TFT LCD liquid-crystal display devices with the ability to enable good screen and image quality for the moving images.

Applications of the invention include:

Use YUV and other compression algorithms for the frame buffer data.

Xenon Strobo-flash tube can be used as a backlight light source.

Allows several frame intervals to generate over-drive data and adaptive over-drive data (first over-drive data, second over-drive data, and third over-drive data).

The over-drive data generation can be implemented in a display controller, separated from LCD panel controller, using the same emphasizing scheme/algorithm. Further, the techniques for over-drive data generation can be applied to any input data which is graphical in nature, such as those originating from a processing engine such as the CPU of a computer system, a dedicated graphics processor, or any component of an information or computer system.

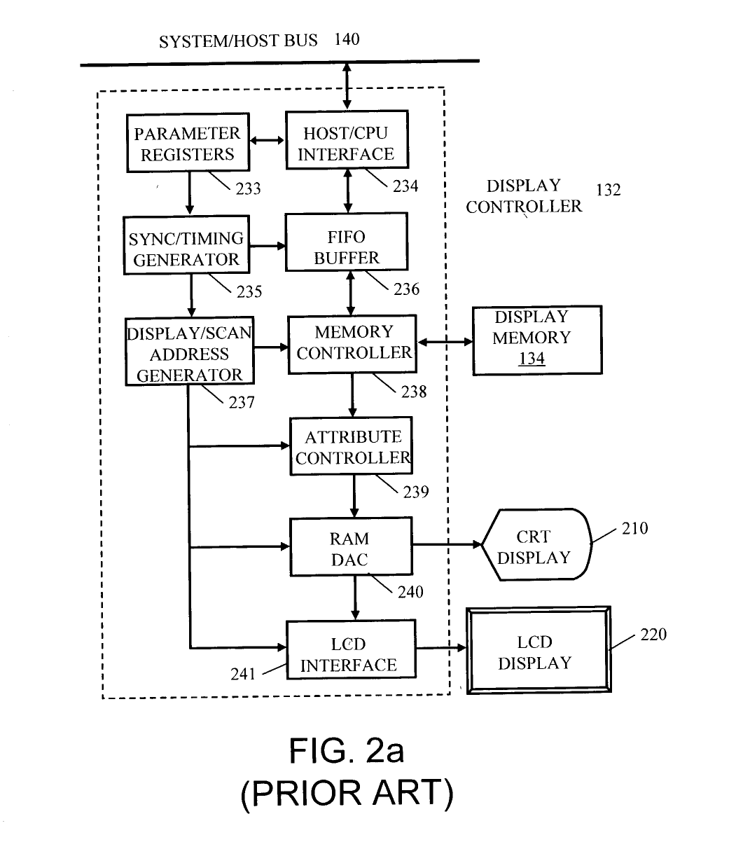

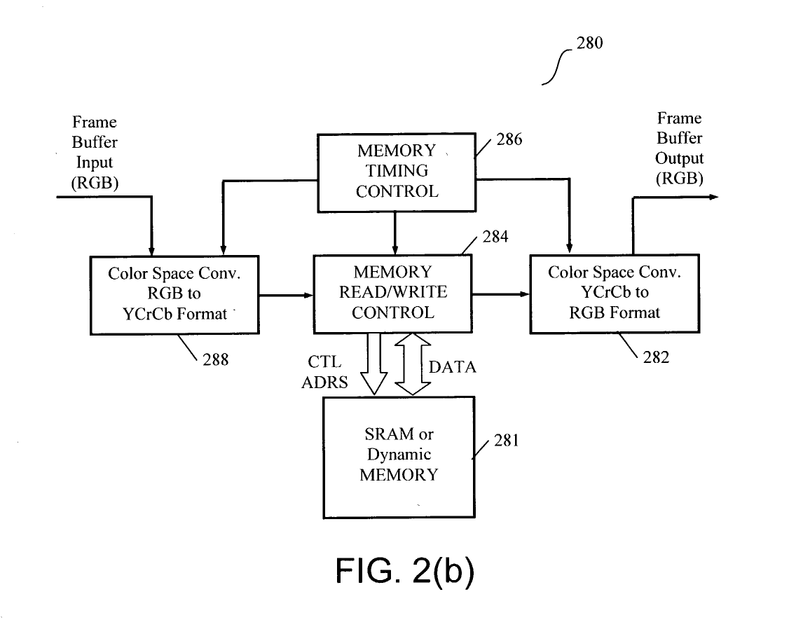

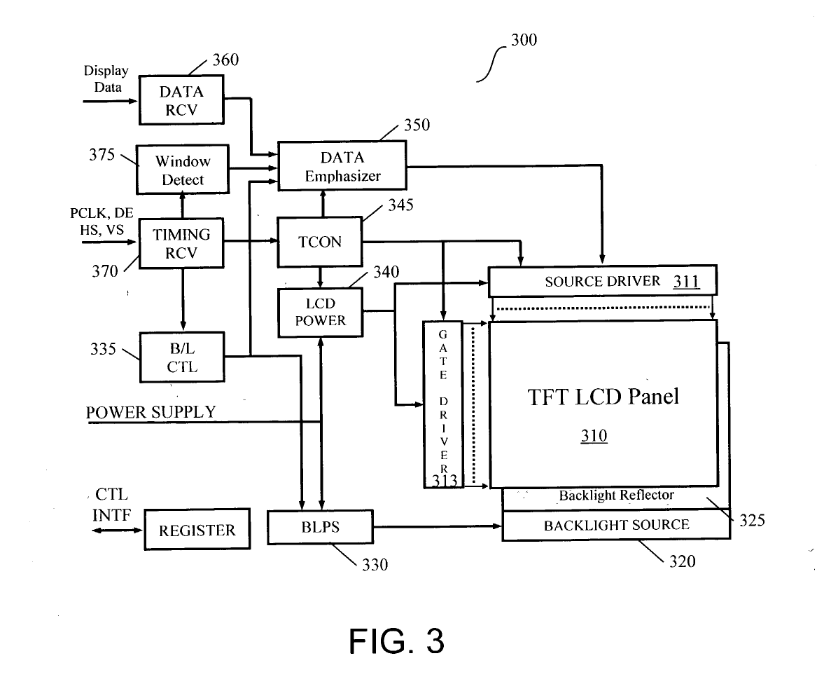

FIG. 3 illustrates a TFT LCD panel system block diagram according to at least one embodiment of the invention. Display Data is RGB 3×8-bit digital input and PCLK, DE, HS, and VS are timing input signals originating from the display controller coming through the LCD Interface (as shown in FIG. 2(a).)

DATA RCV block 360 receives input data and outputs this as needed to DATA Emphasizer 350. TIMING RCV block 370 receives all timing signals and outputs these to TCON 345, B/L (Backlight) CTL 335, and Window Detect block 375 as needed. TCON 345 generates further internal timing control signals for DATA Emphasizer 350, SOURCE DRIVER 311, GATE DRIVER 313, and LCD POWER 340. LCD POWER block 340 includes a DC-to-DC converter and generates relatively high voltages for SOURCE DRIVER 311 and GATE DRIVER 313.

B/L CTL block 335 generates backlight control signals and outputs to a BLPS (backlight power supply inverter) 330. BLPS 330 generates high voltage for backlight lighting. This voltage value depends on the type of backlight source 320 (e.g. CCFL tube, LED diode, or Xenon Strobo tube) that is used. Necessary electric power is supplied from available system voltage from computer system. LCD POWER 340 and BLPS 330 blocks convert the voltage to power all drivers and backlight source 320.

Window Detect block 375 detects the video window area based on given register value on the screen and sends a VIDEO WINDOW SIGNAL to DATA Emphasizer 350. If VIDEO WINDOW is enabled, DATA Emphasizer 350 modifies incoming data in the VIDEO WINDOW. DATA Emphasizer 350 passes through display data outside VIDEO WINDOW (it does not perform data modification.). If VIDEO WINDOW is not enabled, DATA Emphasizer 350 modifies incoming data all over the screen.

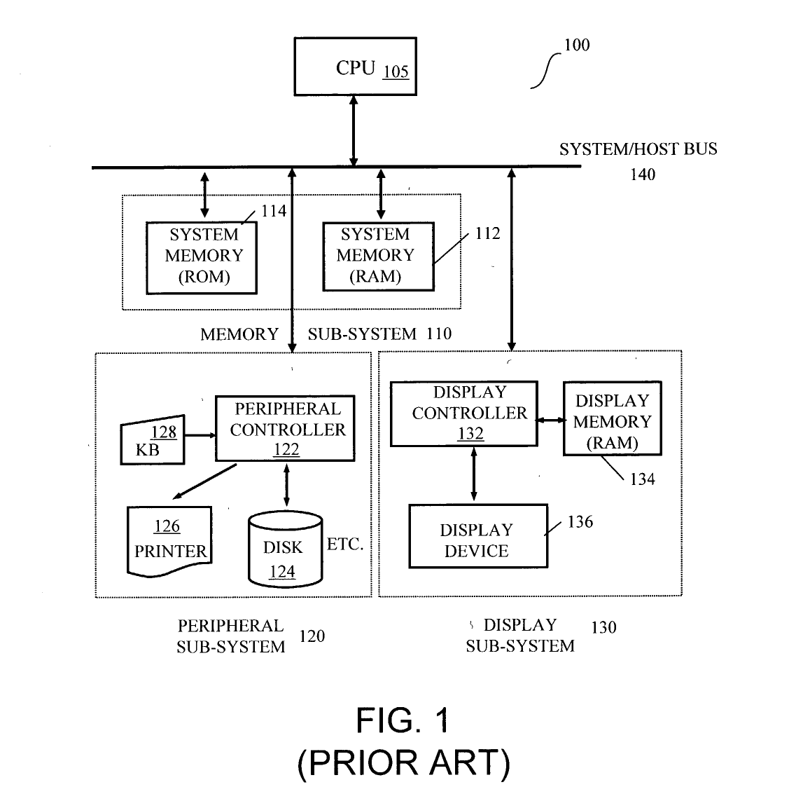

All necessary parameters for above operations are given by register values from the REGISTER block, which are written and read through a CTL INTF (control interface) by the system software as one of peripherals from a computer system such that those shown in FIG. 1.

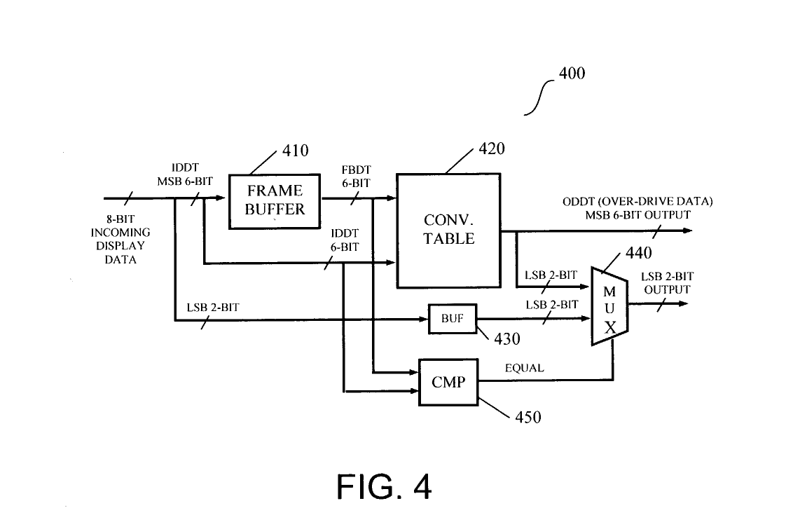

FIG. 4 is an example of a DATA Emphasizer for an over-drive algorithm according to the invention. Input data are 8-bit RGB (Red, Green and Blue) component data. This data-emphasizing block 400 is commonly applied to all R, G, or B data.

FRAME BUFFER 410 makes a one frame time delay between its input to output with the bus width being 6-bit wide. The input data is referred to as IDDT (input display data) and output data of frame buffer 410 is referred to as FBDT (frame buffer data). The IDDT and FBDT become input to the CONV. TABLE 420, which then accesses its internal memory (conversion table) and outputs 8-bit over-drive data. This conversion table 420 is configured to generate over-drive emphasizing data based on two IDDT and FBDT values. The output data is referred to as ODDT (over-drive data). LSB 2-bit data are multiplexed by MUX 440 and selected to output as ODDT LSB 2-bit. This MUX 440 select IDDT LSB 2-bit when IDDT=FBDT using CMP (comparator) 450 output equal signal. BUF logic 430 adjusts clock timing between ODDT and IDDT.

If the two input data (IDDT and FBDT) are the same, output data becomes as the same value as the IDDT. If two input data are not the same, then the output data is converted based on the values (IDDT−FBDT) and FBDT.

The output data (ODDT) is:

ODDT=IDDT+(IDDT−FBDT)×Factor Function (IDDT, FBDT) or

ODDT=IDDT+Factor Function′ (IDDT, FBDT).

The Factor Function (IDDT, FBDT) is variable function modeling TFT response time (RT-on and RT-off). This function decides how much to emphasize over-drive data and depends upon IDDT, FBDT, RT-on and RT-off values. The Factor Function′ (IDDT, FBDT) embeds the multiplied term (IDDT−FBDT) into the Factor Function (IDDT, FBDT), and eliminates the need for a multiply operation.

If VIDEO WINDOW is enabled, this over-drive data emphasizer 400 modifies incoming data in the VIDEO WINDOW and it passes through display data outside of the VIDEO WINDOW. If VIDEO WINDOW is disabled, then all display data is emphasized to the LCD.

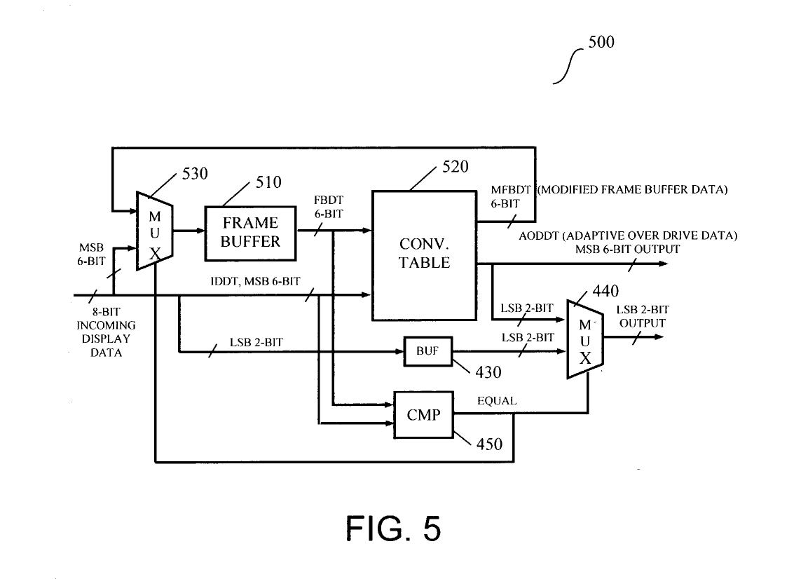

FIG. 5 illustrates an example of a DATA Emphasizer block detail for an adaptive over-drive algorithm. The input data are 8-bit RGB data. This example has a different CONV. TABLE 520, that additionally outputs MFBDT (modified frame buffer data, 6-bit) (in addition to the output of CONV. TABLE 420), and one MUX 530 for FRAME BUFFER 510 input data selection. The 6-bit conversion table 520 output is named AODDT (adaptive over-drive data). AODDT output can more accurately emphasize than ODDT data shown in FIG. 4. When IDDT and FBDT are not equal, AODDT and MFBDT are generated and MFBDT is selected to be written to FRAME BUFFER 510 for the next AODDT signal generation. MFBDT conversion table 520 output data are prepared to compensate (reverse direction emphasize) by feedback previous adaptive over-drive emphasizing data.

The output data AODDT and MFBDT are:

AODDT=IDDT+(IDDT−FBDT) * Adaptive Factor Function (IDDT, FBDT) or

AODDT=IDDT+Adaptive Factor Function′ (IDDT, FBDT); and

MFBDT=IDDT+(IDDT−FBDT) * Modify Factor Function (IDDT, FBDT) or

MFBDT=IDDT+Modify Factor Function′ (IDDT, FBDT).

Adaptive Factor Function (IDDT, FBDT) and Modify Factor Function (IDDT, FBDT) are variable functions of TFT response time, RT-on and RT-off. These functions decide how much to emphasize and compensate adaptive over-drive data from one frame to next frame and depends on IDDT, FBDT, RT-on and RT-off. In some embodiments of the invention, the multiplication of the term (IDDT−FBDT) by each of the Modify Factor Function and Adaptive Factor Function can be embedded therein such that different functions Modify Factor Function′ and Adaptive Factor Function′ can be used respectively, instead, thereby eliminating the necessity of a multiply operation.

If VIDEO WINDOW is enabled, this adaptive over-drive data emphasizer 500 modifies incoming data in the VIDEO WINDOW and it passes through display data outside of the VIDEO WINDOW. If VIDEO WINDOW is disabled, then all display data for the LCD is modified.

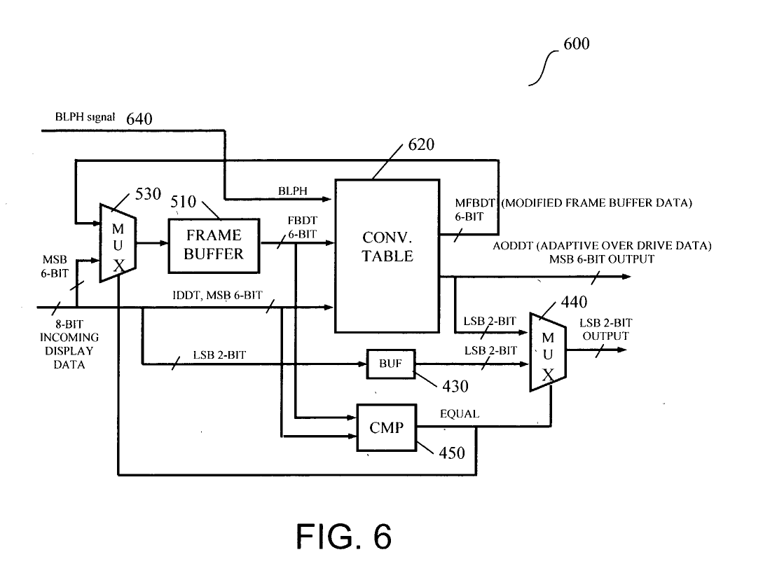

FIG. 6 illustrates an example of a DATA Emphasizer block for an adaptive over-drive algorithm with a BLPH signal input. DATA Emphasizer 600 has an additional CONV. TABLE 620 input BLPH (backlight phase) signal 640 which indicates relative position change with backlight lighting timing. AODDT and MFBDT is adjusted to their optimum values using this BLPH and depending on-the screen line positioning relative to the backlight lighting timing. Appendices A and B show representative AODDT where BLPH=0, and BLPH=1, respectively. Appendix C shows representative MFBDT.

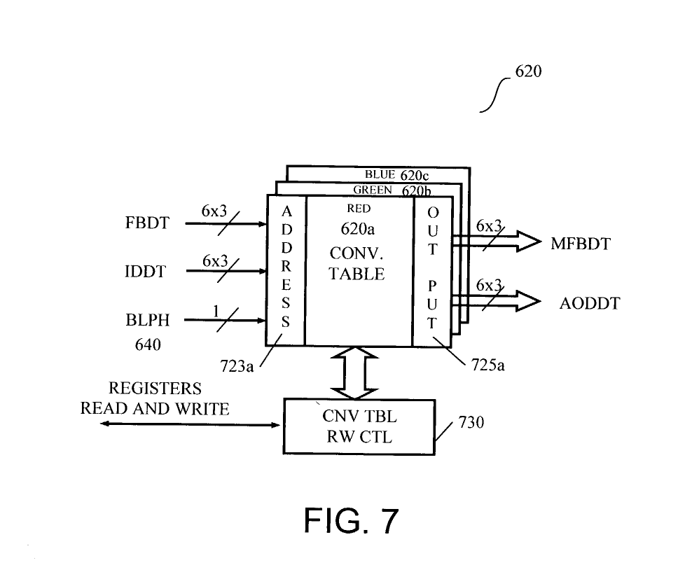

FIG. 7 illustrates an example of a Conversion Table block for an adaptive over-drive algorithm with a BLPH signal input. A Conversion Table (CONV. TABLE 420) for first over-drive data generating algorithm does not have MFBDT output, while it would so for an adaptive over-drive data generating algorithm (according to CONV. TABLE 520). The BLPH signal 640 can be eliminated, if the system does not use backlight phase data compensation.

Conversion Table 620 has adaptive over-drive data and backlight compensation inputs that are three sets of input color signals (6-bit FBDT and 6-bit IDDT for each RED, GREEN, and BLUE) and a one-bit BLPH signal 640 which access the Table 620 through address lines 723a. The BLPH signal 640 is common to RED, GREEN, and BLUE conversion sub-tables which make up the Conversion Table 620. There are three memory conversion sub-tables 620a, 620b, and 620c within Conversion Table 620 for each RED, GREEN, and BLUE components, respectively. The outputs are also three sets of 6-bit MFBDT and 6-bit AODDT data, each set corresponding to one of Red, Green and Blue which are accessed by output lines 725a. The conversion sub-tables 620a, 602b, and 620c are readable/writeable memory and the system can change the data therein using register read and write operation through conversion table read/write control block 730.

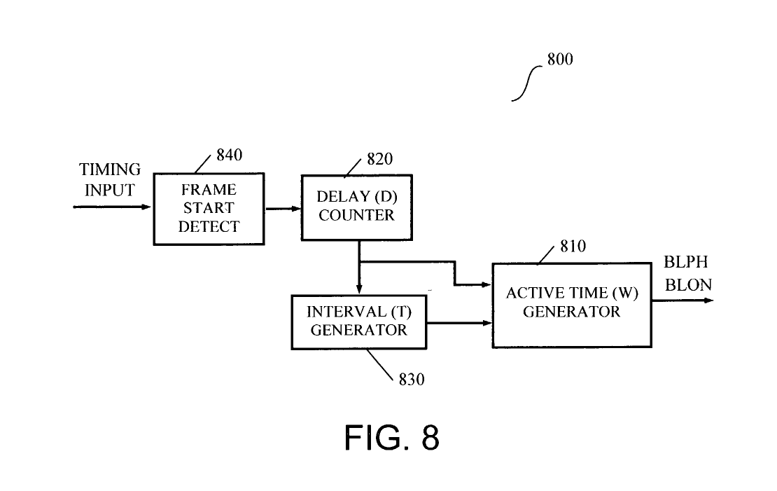

FIG. 8 illustrates an example of a backlight timing generator. Input signals to generator 800 are timing signals from TIMING RCV block 370 (see FIG. 3). Using these timing signal inputs, FRAME START DETECT logic 840 detects VDE (vertical display enable timing) from VS (vertical synchronous signal) and a DE (Display Enable signal). This detection resets and restarts all counters in generator 800. A DELAY (D) COUNTER 820 counts delay intervals by counting HS (Horizontal synchronous signal) as the unit timing clock signal. An INTERVAL (T) GENERATOR 830 starts counting after receiving a signal from DELAY (D) COUNTER 820. ACTIVE TIME (W) GENERATOR 810 starts counting after receiving signals from both DELAY (D) COUNTER 820 and INTERVAL (T) GENERATOR 830 ACTIVE TIME (W). GENERATOR 810 generates a BLON signal for the backlight turn-on width signal and BLPH signal for the backlight phase signal.

If the backlight source is an LED (Light Emitting Diode) backlight, three BLON signals are prepared for RGB backlight LEDs, because LED backlights need to control color balance by adjusting each active time width. CCFL tube and Xenon tube backlights can function with only one BLON output signal. All of the above counters (810, 820 and 830) can be implemented with necessary parameter registers to control delay, width, and interval timings independently.

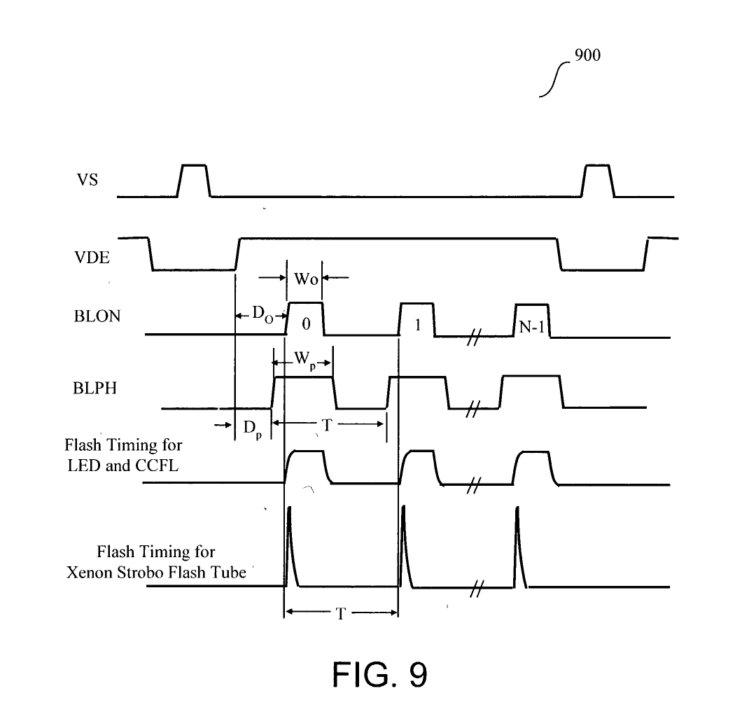

FIG. 9 illustrates a timing chart 900 of backlight related signals. Signal VS is the one of the timing input signals to the LCD Panel and it indicates the frame start timing and interval. The FRAME START DETECT block 840 detects the first DE signal after a VS and generates a VDE (Vertical Display Enable). The signal VDE starts all backlight control timing counters. DELAY (D) COUNTER 820 counts backlight on timing delay D₀ and activates the first BLON pulse of width W₀ and INTERVAL (T) GENERATOR 830. The output pulse from INTERVAL (T) GENERATOR 830 activates thereafter and follows with the BLON pulse. The BLPH signal is generated the same way and pulses at delay time Dₚ with a width Wₚ. BLON and BLPH have intervals T and a repeat time of N as their common parameters. The BLON pulse turns on LED and CCFL backlight and triggers the Xenon Strobo flash. LED backlights need to have three BLON signals for R, G, and B lighting independently to control color balance.

A narrower BLON pulse (shorter W₀) makes for a sharper edge because a tracing human eye feels the display image at the BLON (W₀) timing, wherein backlight is turned on. It avoids accumulation of edge images that cause blurring, if the BLON pulse is a narrow pulse.

Xenon strobo flash backlight makes very narrow impulse lighting and it simulates CRT display flushing. It is an ideally narrow flush lighting backlight which can eliminate blurring of the edges of motion picture in an LCD panel.

Multiple BLON (W₀) timing makes for a sharper and brighter feeling, because the sum total of lighting becomes greater. It equalizes artifacts of image position on display screen and backlight phase relationships all over the screen. It also eliminates screen flicker sensation completely.

As mentioned, the BLPH is a DATA Emphasizer control signal to adjust/compensate screen vertical position and backlight blink timing relative artifacts. Blinking backlight, using the BLON signal to turn on the backlight, can reduce temperature increases and average power consumption. Thus, this scheme can accommodate a higher voltage and more current. It can make for better lighting efficiency by averaging the effect in contrast with a normal continuously on backlight scheme. Multiple BLON and BLPH controls have the same effect in that they remove artifacts of backlight blink timing and relative screen position LCD drive timing.

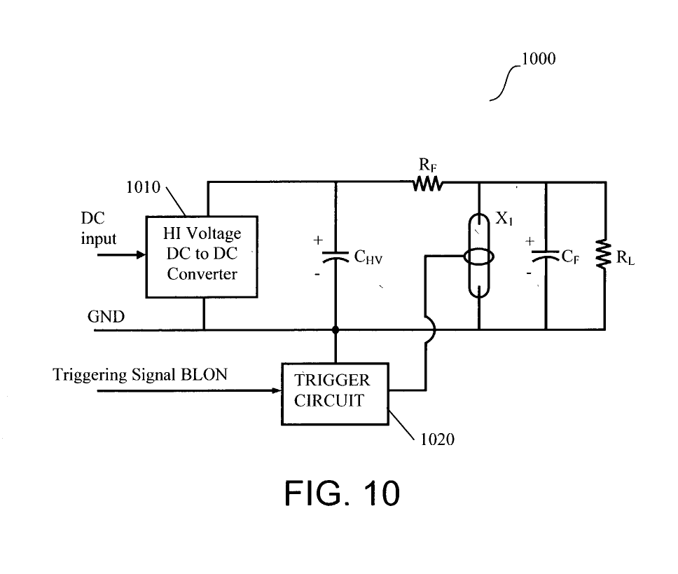

FIG. 10 is an example of a Xenon tube backlight high voltage generator and trigger circuit 1000. HI Voltage DC-to-DC Converter 1010 generates enough voltage to flash xenon strobo tube X₁. Capacitor C_{HV} makes a flattened and smoothed high voltage power source. Electric energy is charged into capacitor C_{F} through resistor R_{F}. C_{F} and R_{F} create a time constant of charging speed which is designed to follow the flashing period T. The discharging electric energy charges into capacitor C_{F} with flashing period T, and is designed to meet xenon tube X₁. R_{L} is a leaking resistor to discharge electric energy in capacitor C_{F} when the system is power off.

Triggering circuit 1020 is designed to meet flash period T and generates enough high voltage to trigger tube X₁. BLON signal controls only triggering timing (lighting start timing). The width information is not used by circuit 1020. DC-to-DC converter 1010 (or an inverter) for LED backlight and CCFL tube backlights may be implemented by using well-known designs.

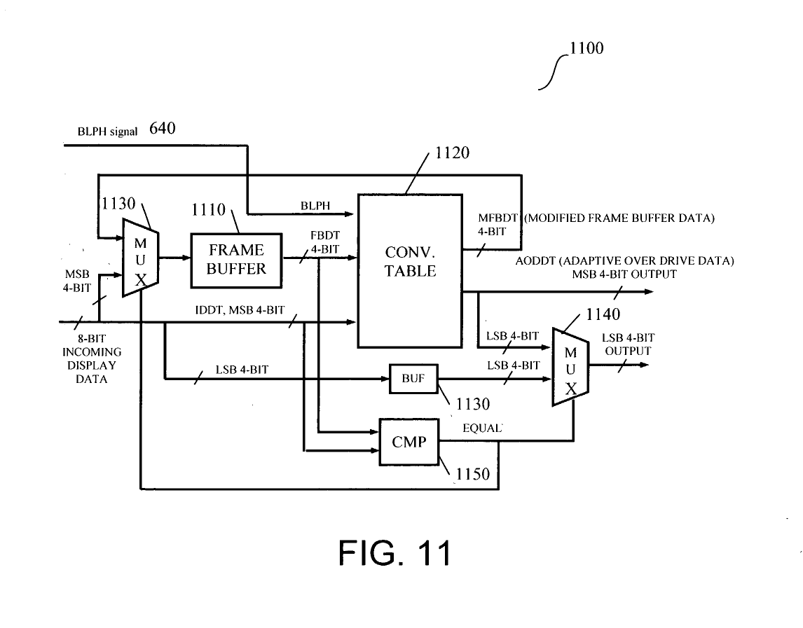

FIG. 11 is an exemplary embodiment of a DATA emphasizer for adaptive over-drive output with a BLPH input. CONV. TABLE 1120 takes as inputs frame buffer data FBDT that is 4 bits (rather than 6 bits as shown in FIG. 6) and the 4 MSBs (most significant bits) of the incoming display data IDDT (which is 8 bit RGB) as other input data. The 4 LSBs (least significant bits) of the incoming display data is sent to BUF 1130 for possible selection by MUX 1140. FRAME BUFFER 1110 buffers either 4 bit MFBDT (modified frame buffer data) from the previous cycle output from CONV. TABLE 1120 or the 4 MSBs of the incoming display data. This selection is performed by a MUX 1160 and is controlled by the EQUAL signal output by CMP 1150. CMP 1150 generates an EQUAL signal at if true the 4 MSBs of IDDT and FBDT are equal and returns false if they are not. If EQUAL is true, then MUX 1150 selects the 4 MSBs of the incoming display data and if not, then selects the MFBDT feedback of the previous cycle. Likewise, if EQUAL is true, MUX 1140 selects the 4 LSBs of the FDDT which is buffered through BUF 1130 and otherwise selects the AODDT output (4 LSBs thereof) from CONV. TABLE 1120.

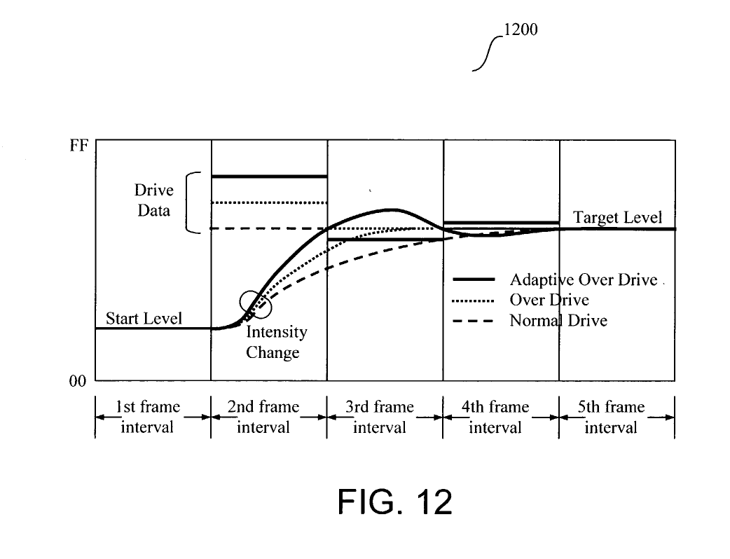

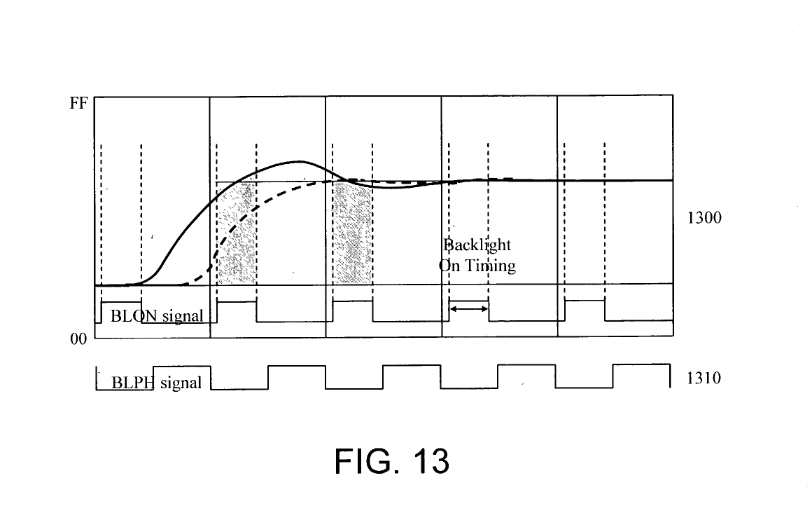

FIG. 12 is an exemplary adaptive over-drive data and intensity timing chart. This chart 1200 shows the comparison of LCD intensity change and drive data waveforms as among normal drive, over-drive, and adaptive over-drive data types.

The first frame interval shows start drive data and start level (tone or intensity) from previous frame before a picture is moving. The second frame to the fourth frame intervals show incoming display data changing to a target level as well as drive data waveforms and intensity change curves depending on each drive scheme. The fifth frame interval shows all intensity curves convergent to the target level.

The long-dashed line and curve shows normal drive data and its LCD intensity response. The normal drive data is applied as target drive data to the LCD without modification. Its LCD intensity response curve shows slow steady progression to the target level. This rising speed is the LCD panel native response time (T_{ON} or T_{OFF}). This example shows that it takes 3 frames to reach target level.

The short-dashed line and curve shows over-drive data and its LCD intensity response. The over-drive data is applied emphasized drive data in the second frame interval (the first frame of picture move) to speed up its LCD intensity response. This example shows that it takes 2 frames to reach target level.

The solid line and curve shows adaptive over-drive data and its LCD intensity response. The adaptive over-drive data applies a stronger emphasizing drive than does over-drive data in the second frame interval (the first frame of the picture's move) to make it over-shoot the desired response. Then, in the third frame the adaptive over-drive data compensates the over-shooting in the opposite direction and converges quickly to the target. This example shows that it takes less than one frame to reach target level. As mentioned above, the CONV. TABLE output, AODDT and MFBDT. When the system detects a picture move (i.e. a IDDT and FBDT change), then MFBDT is written to the FRAME BUFFER. In the next frame interval, the MFBDT is read and is compared with IDDT and output for the next emphasizing/compensation data and MFBDT. This data emphasizing operation repeats and perform adaptive over-drive until convergence occurs to the target level.

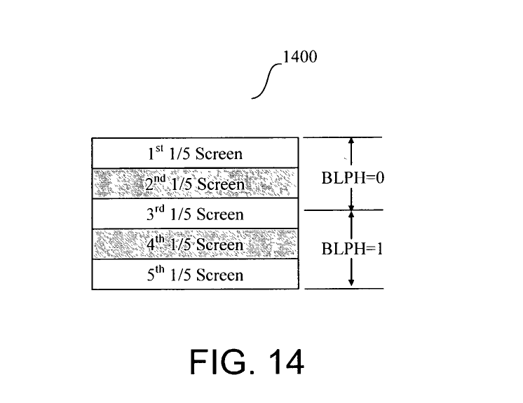

FIG. 13 exemplifies adaptive over-drive data and timing chart 1300 with BLPH control. The solid curve shows adaptive over-drive intensity response with BLPH=0 and this intensity waveform is from the 2nd ⅕^{th} of the screen area of the LCD panel. The dashed curve shows adaptive over-drive intensity response with BLPH (1310)=1 and this intensity waveform is from 4th ⅕^{th} of the screen area of the LCD panel.

When BLPH (1310)=1, over-shooting of adaptive over-drive becomes smaller than BLPH (1310)=0. In this figure, the BLON waveform indicates backlight on timing and BLPH waveform indicates CONV. TABLE control signal from backlight control block. Because the human eye sees LCD intensity when BLON=1 (when backlight is on), the part labeled by left-to-right, up-sloping diagonal hatching is the intensity for the 2nd ⅕^{th} of screen area of the LCD panel after one frame of a picture move and the part labeled by left-to-right down-sloping diagonal hatching is the intensity for the 4th ⅕^{th} of screen area. The average intensity of both areas would appear as the same intensity as target level. Using BLPH 1310, the data emphasizer modification can hide over-shooting. This pattern 1400 as it relates to the BLPH signal is shown in FIG. 14.

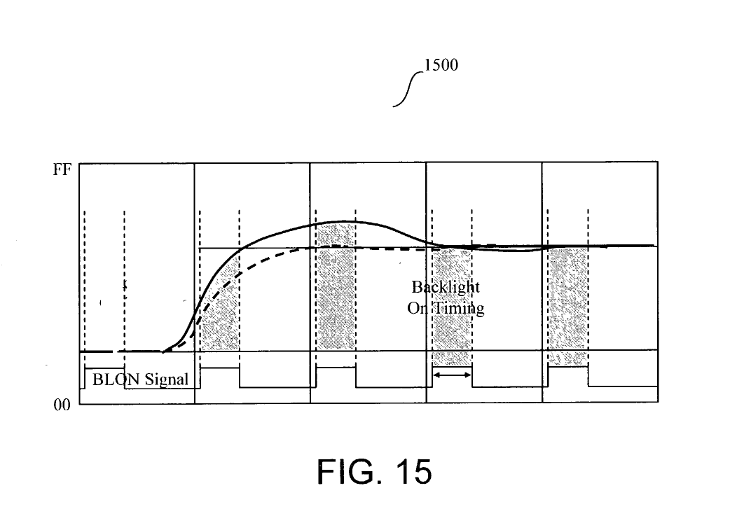

FIG. 15 is another example of adaptive over-drive intensity timing chart 1500 with BLPH compensation control. The dashed line curve shows adaptive over-drive intensity response with BLPH=1 and this intensity waveform is from 4th ⅕^{th} of screen area of the LCD panel the same as that shown in FIGS. 13 and 14. The solid line curve shows another adaptive over-drive intensity response with BLPH=1 and this intensity waveform is from 4th ⅕^{th} of screen area of the LCD panel as well. It exhibits more over-shooting of the intensity waveform than adaptive over-drive intensity response with BLPH=0 from the 2nd ⅕^{th} of screen area of the LCD panel. The average intensity of diagonally hatched areas appears to be identical in intensity to the target level. It shows less than one frame is needed to reach the target level and looks quicker to converge than the normal drive waveform. Appendices A and B show representative AODDT where BLPH=0, and BLPH=1, respectively.

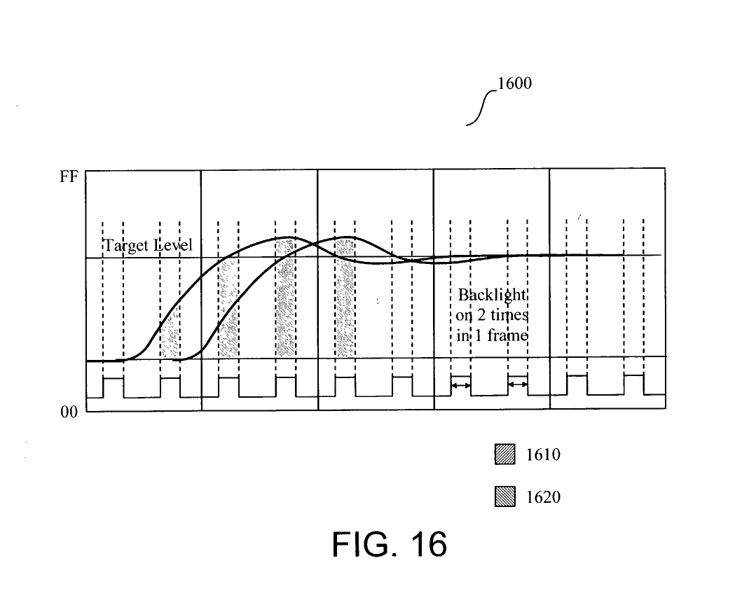

FIG. 16 is an example of adaptive over-drive intensity timing chart 1600 with two lightings. The part 1610 of chart 1600 is the intensity waveform for the 2nd ⅕^{th} of screen area of the LCD panel and the part 1620 is the intensity waveform for the 4th ⅕^{th} of screen area when the backlight is on. The average intensity looks the same between two areas, because the backlight is on two times in one frame and the relative phase relationship between backlight timing and driving timing become the same. It occurs in all LCD display areas to equalize the human eye's intensity feeling, if the number of times for backlight-on increases to more than once. Multiple backlight flashing makes for a brighter screen and sharper image edge, because such backlight-on timing can make narrower response and total backlight on time becomes longer.

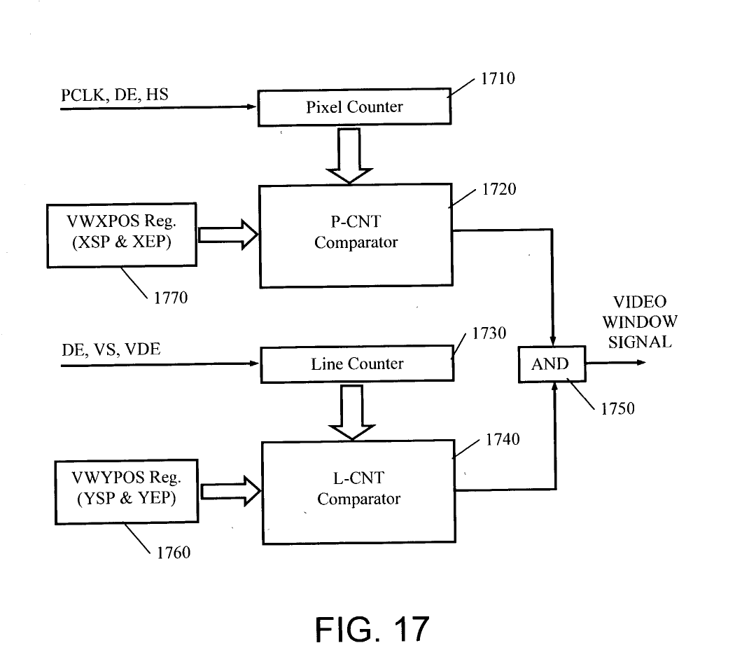

FIG. 17 is an example of a video window detecting timing generator. Pixel Counter 1710 is reset by the HS signal and counts up by PCLK when DE=1 and generates the current horizontal screen position count of incoming display data. This number is compared by P-CNT Comparator 1720 with VWXPOS Register (XSP & XEP) 1770 and generates video window horizontal signal between XSP and XEP position (video window X start position and X end position). Line Counter 1730 is reset by the VS signal and counts up according to the DE ON signal when VDE=1 and generates the current vertical screen position count of incoming display data. This number is compared with the value from VWYPOS (YSP & YEP) Register 1760 by L-CNT Comparator 1740 and generates video window vertical signal between YSP and YEP position (video window Y start position and Y end position). The video window horizontal signal and video window vertical signal are ANDed together (block 1750) to generate the complete video window signal.

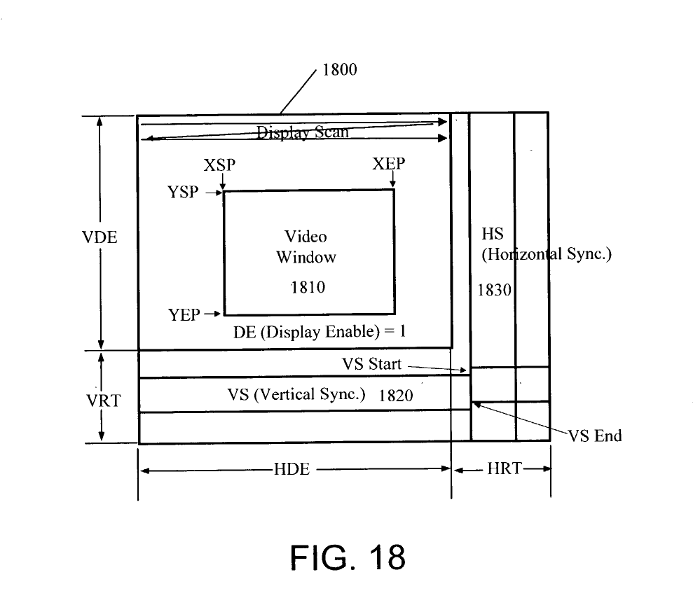

FIG. 18 is a diagram of video window and display timing. The display scan starts from top-left corner (line number=0 and DE=1) and scans horizontally left to right. When DE becomes 0, HRT (horizontal retrace) starts. HS (Horizontal Sync.) 1830 turns on and off in between horizontal retrace timing. It repeats to finish the whole display screen line (VDE becomes 0) and then VRT (vertical retrace) starts. VS (Vertical Sync.) 1820 turns on and off at the starting edge of HS 1830 in the VRT (vertical retrace timing) interval. The Video Window 1810 is defined by VWXPOS (XSP & XEP) for its horizontal position and VWYPOS (YSP & YEP) for its vertical position.

What is claimed is:

1. An apparatus for generating a set of drive data from a set of current input data, said set of drive data intended for output on a Liquid Crystal Display, said apparatus comprising:
a data emphasizer which determines a variation between a set of previous input data and said set of current input data, said variation the basis for generating said set of drive data.

2. An apparatus according to claim 1 further comprising:
a backlight control mechanism, said backlight control mechanism providing a backlight phase signal indicating the phase of a backlight provided to said Liquid Crystal Display, said backlight phase signal and said variation utilized to generate said set of drive data.

3. An apparatus according to claim 1 wherein said data emphasizer comprises:
a frame buffer configured to store a first portion of said set of previous input data until said set of drive data is generated and configured afterwards to store a first portion of said set of current input data in anticipation of generating a next set of drive data; and
a conversion table, said conversion table coupled to said frame buffer to receive said first portion of said set of previous input data, said conversion table further configured to receive said first portion of said set of current input data and generate a first portion of a set of over-drive data therefrom.

4. An apparatus according to claim 3 wherein said data emphasizer further comprises:
an intermediate buffer for temporarily storing a second portion of said set of current input data;
a multiplexer configured to select as output one of data from said intermediate buffer and a second portion of said set of over-drive data; and
a comparator comparing said first portion of said set of current input data with said first portion of said set of previous input data, wherein if said comparator determines said first portions are equal, said comparator causing said multiplexer to select said data from said intermediate buffer, and if said comparator determines that said first portions are not equal, then causing said multiplexer to select said second portion of said over-drive data.

5. An apparatus according to claim 3 wherein said emphasizing factor varies dynamically over the area of the liquid crystal display, further wherein said emphasizing factor is a function of the response time of said liquid crystal display, said set of current input data and said set of previous input data.

6. An apparatus according to claim 3 wherein said frame buffer stores said set of previous input data in an RGB format.

7. An apparatus according to claim 3 wherein said frame buffer stores said set of previous input data in a compressed format.

8. An apparatus according to claim 7 wherein said compressed format is YCrCb.

9. An apparatus according to claim 3 further comprising:
a windowing mechanism configured to select a window of said liquid crystal display, said window a sub-set of the area of output of said liquid crystal display, wherein said set of over-drive data is the same as said set of current input data where said set of current input data is destined to be output outside of said window and is emphasized by said data emphasizer using said emphasizing factor where said set of current input data is destined to be output inside of said window.

10. An apparatus according to claim 1 wherein said data emphasizer comprises:
a frame buffer configured to store as frame buffer data one of a first portion of said set of previous input data and a previous modified frame buffer data until said set of drive data is generated and configured afterwards to store a frame buffer data one of a first portion of said set of previous input data and a first portion of current modified frame buffer data in anticipation of generating a next set of drive data; and
a conversion table, said conversion table coupled to said frame buffer to receive said frame buffer data, said conversion table further configured to receive said first portion of said set of current input data and generate a first portion of a set of adaptive over-drive data and modified frame buffer data therefrom.

11. An apparatus according to claim 10 wherein said data emphasizer further comprises:
an intermediate buffer for temporarily storing a second portion of said set of current input data;
a first multiplexer configured to select as output one of data from said intermediate buffer and a second portion of said set of adaptive over-drive data; and
a comparator comparing said first portion of said set of current input data with said frame buffer data, wherein if said comparator determines they are equal, said comparator causing said first multiplexer to select said data from said intermediate buffer, and if said comparator determines that they are not equal, then causing said first multiplexer to select said second portion of said adaptive over-drive data.

12. An apparatus according to claim 11 further comprising:
a second multiplexer selecting said frame buffer data to be written with previous modified frame buffer data if said comparator determines said first portion of said set of current input data and said frame buffer data are not equal, and to be written with said first portion of said set of previous input data if said comparator determines said first portion of said set of current input data and said frame buffer data are equal.

13. An apparatus according to claim 10 wherein said adaptive factor and said modify factor varies dynamically over the area of the liquid crystal display, further wherein said adaptive factor and said modify factor are a dynamic function of the response time of said liquid crystal display, said set of current input data and said set of previous input data.

14. An apparatus according to claim 10 wherein said frame buffer stores said set of previous input data in an RGB format.

15. An apparatus according to claim 10 wherein said frame buffer stores said set of previous input data in a compressed format.

16. An apparatus according to claim 15 wherein said compressed format is YCrCb.

17. An apparatus according to claim 10 further comprising:
a windowing mechanism configured to select a window of said liquid crystal display, said window a sub-set of the area of output of said liquid crystal display, wherein said set of over-drive data is the same as said set of current input data where said set of current input data is destined to be output outside of said window and is emphasized by said data emphasizer using said adaptive factor where said set of current input data is destined to be output inside of said window.

18. An apparatus according to claim 2 wherein said data emphasizer comprises:
a frame buffer configured to store as frame buffer data one of a first portion of said set of previous input data and a previous modified frame buffer data until said set of drive data is generated and configured afterwards to store a frame buffer data one of a first portion of said set of previous input data and a first portion of current modified frame buffer data in anticipation of generating a next set of drive data; and
a conversion table, said conversion table coupled to said frame buffer to receive said frame buffer data, said conversion table further configured to receive said first portion of said set of current input data and to receive said backlight phase signal and generate a first portion of a set of adaptive over-drive data and modified frame buffer data therefrom.

19. An apparatus according to claim 18 wherein said data emphasizer further comprises:
an intermediate buffer for temporarily storing a second portion of said set of current input data;
a first multiplexer configured to select as output one of data from said intermediate buffer and a second portion of said set of adaptive over-drive data; and
a comparator comparing said first portion of said set of current input data with said frame buffer data, wherein if said comparator determines they are equal, said comparator causing said first multiplexer to select said data from said intermediate buffer, and if said comparator determines that they are not equal, then causing said first multiplexer to select said second portion of said adaptive over-drive data.

20. An apparatus according to claim 19 further comprising:
a second multiplexer selecting said frame buffer data to be written with previous modified frame buffer data if said comparator determines said first portion of said set of current input data and said frame buffer data are not equal, and to be written with said first portion of said set of previous input data if said comparator determines said first portion of said set of current input data and said frame buffer data are equal.

21. An apparatus according to claim 18 wherein said adaptive factor and said modify factor varies dynamically over the area of the liquid crystal display, further wherein said adaptive factor and said modify factor are a dynamic function of the response time of said liquid crystal display, said set of current input data, said set of previous input data and said backlight phase signal.

22. An apparatus according to claim 18 wherein said frame buffer stores said set of previous input data in an RGB format.

23. An apparatus according to claim 18 wherein said frame buffer stores said set of previous input data in a compressed format.

24. An apparatus according to claim 23 wherein said compressed format is YCrCb.

25. An apparatus according to claim 20 further comprising:
a windowing mechanism configured to select a window of said liquid crystal display, said window a sub-set of the area of output of said liquid crystal display, wherein said set of over-drive data is the same as said set of current input data where said set of current input data is destined to be output outside of said window and is emphasized by said data emphasizer using said adaptive factor where said set of current input data is destined to be output inside of said window.

26. An apparatus for controlling a backlight for a liquid crystal display, comprising:
means to flash said backlight on and off at least more than once during any one frame interval of said liquid crystal display output; and
means for synchronizing between frames displayed on said liquid crystal display.

27. An apparatus according to claim 26 wherein said means to flash includes:
means to control the period over which said backlight is flashed; and
means to generate at least one backlight on control signal.

28. An apparatus for controlling a backlight for a liquid crystal display, comprising:
means to flash said backlight on and off during any one frame interval of said liquid crystal display output;
means for synchronizing between frames displayed on said liquid crystal display;
means to adjust the phase of said flashing backlight; and
means to output a phase signal representative of said phase.

29. An apparatus according to claim 28 wherein said phase signal is utilized in generating drive data to drive said liquid crystal display.

30. An apparatus for controlling a backlight for a liquid crystal display, comprising:
means to flash said backlight on and off during any one frame interval of said liquid crystal display output; and
means for synchronizing between frames displayed on said liquid crystal display wherein said backlight is from a Xenon strobo flash source.

31. An apparatus according to claim 1 wherein said set of current and set of previous input data are from a processing engine.

32. An apparatus according to claim 31 wherein said processing engine is part of a display controller.

33. An apparatus according to claim 31 wherein said processing engine is a component of a computer system.
